(19) United States
(12) Patent Application Publication
(10) Pub. No.: US 2006/0134443 A1
(43) Pub. Date: Jun. 22, 2006

(54) Flexible metal foil-polyimide laminate

(75) Inventors: Michio Aizawa, Ibaraki (JP); Masahiro Usuki, Ibaraki (JP); Shigehiro Hoshida, Ibaraki (JP); Tadashi Amano, Ibaraki (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Shin-Etsu Chemical Co., Ltd., Tokyo (JP)

(21) Appl. No.: 10/544,346

(22) PCT Filed: Jun. 16, 2004
(86) PCT No.: PCT/JP04/08773

§ 371 Date: Aug. 3, 2005

(30) Foreign Application Priority Data
Jun. 25, 2003 (JP) 2003-181341

(51) Int. Cl. B32B 27/00

(52) U.S. Cl. 428/473.5

(57) ABSTRACT

A flexible metal foil/polyimide laminate consists of all three layers, a polyimide film, a metal foil, and a polyimide resin layer disposed between the polyimide film and the metal foil.

### TECHNICAL FIELD

This invention relates to flexible metal foil/polyimide laminates which have become widespread in the electronic industry and more particularly, to flexible polyimide/metal foil laminates having excellent dimensional stability and heat resistance.

### BACKGROUND ART

Flexible metal foil laminates are mainly used as substrates for printed wiring boards. Since prior art flexible metal foil laminates are manufactured by bonding metal foils to commercially available polyimide films with adhesives such as epoxy resins, their heat resistance, chemical resistance, flame retardance, electrical properties and the like are governed by the properties of a particular adhesive used. The laminates do not take full advantage of the favorable properties of polyimide film and are insufficient especially in heat resistance. To overcome the drawbacks of prior art flexible metal foil/polyimide laminates using adhesives, an adhesive layer-free flexible metal foil laminate has been developed which is manufactured by casting and coating a polyimide resin or polyimide resin precursor (polyamide acid) varnish directly onto a metal foil.

For example, a method of laminating a plurality of layers of polyimide resins having different chemical structures to prevent curling due to shrinkage during polyimide resin formation has been reported. In this case, the polyimide resin of the layer in contact with the metal foil generally has a lower glass transition temperature (Tg) than the polyimide resins of the remaining layers in order to ensure a bond strength to the metal foil. Likewise for preventing curling, modified polyimide resins, for example, silicone-modified polyimide resins and polyamide-imides are sometimes used.

These flexible metal foil laminates are significantly improved in heat resistance and the like as compared with the prior art flexible metal foil laminates having an adhesive layer of epoxy resin, but are no regarded as fully taking advantage of the favorable properties of polyimide film. In Japanese Patent No. 3,320,516, for example, the polyimide resin responsible for adhesion (Synthesis Example 1) has a Tg of 192° C., which is far below the Tg (430° C.) of commercially available polyimide film (trade name Kapton H by Dupont-Toray Co., Ltd.).

Also, JP-A 2002-326280 addresses the problems associated with the manufacture of a three-layer structure laminate using a thermoplastic resin as an adhesive layer wherein the heat compression bonding generally requires a temperature of 200° C. or higher.

### DISCLOSURE OF THE INVENTION

An object of the invention is to provide a flexible metal foil/polyimide laminate that has improved heat resistance, chemical resistance, flame retardance and electrical properties and takes full advantage of the properties of heat resistant polyimide film.

Making extensive investigations, the inventors have found that the above object of the invention is achievable by forming a polyimide resin layer between a polyimide film and a metal foil, especially by forming a polyimide resin layer having a glass transition temperature (Tg) at least equal to the polyimide film and solvent insolubility.

Specifically, the present invention provides a flexible metal foil/polyimide laminate consisting of all three layers, a polyimide film, a metal foil, and a polyimide resin layer disposed between the polyimide film and the metal foil, wherein the polyimide resin layer is formed by applying a polyimide resin precursor solution to the polyimide film or the metal foil, joining them together, then removing the solvent from the precursor solution and effecting imidization.

### BEST MODE FOR CARRYING OUT THE INVENTION

The polyimide film used in the preparation of the flexible metal foil/polyimide laminate of the invention may be any of polyimide films that are conventionally used in laminates of this type. There may be used films of polyimide resins of the general formula (III) which are obtained from diamine compounds of the general formula (I) and tetracarboxylic acid dianhydrides of the general formula (II), shown below. Commercial products may also be used. Examples of commercial products that can be used herein include

Apical (trade name) by Kaneka Corp. and

Kapton (trade name) by Dupont-Toray Co., Ltd.
H₂N—R₁—NH₂ (I)
Herein R₁ is a divalent radical selected from the group consisting of an aliphatic radical, cycloaliphatic radical, monocyclic aromatic radical, fused polycyclic aromatic radical and non-fused cyclic aromatic radical having aromatics joined directly or via a linking member. 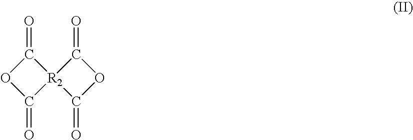
Herein R₂ is a tetravalent radical selected from the group consisting of an aliphatic radical, cycloaliphatic radical, monocyclic aromatic radical, fused polycyclic aromatic radical and non-fused cyclic aromatic radical having aromatics joined directly or via a linking member. 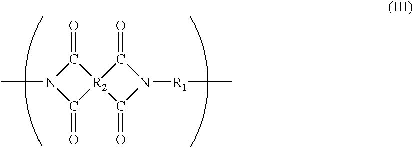
Herein R₁ and R₂ are as defined above.

Examples of the diamine of general formula (I) include o-phenylenediamine, m-phenylenediamine, p-phenylenediamine, m-aminobenzylamine, p-aminobenzylamine, 2-chloro-1,2-phenylenediamine, 4-chloro-1,2-phenylenediamine, 2,3-diaminotoluene, 2,4-diaminotoluene, 2,5-diaminotoluene, 2,6-diaminotoluene, 3,4-diaminotoluene, 2-methoxy-1,4-phenylenediamine, 4-methoxy-1,3-phenylenediamine, benzidine, 3,3′-dichlorobenzidine, 3,3′-dimethylbenzidine, 3,3′-dimethoxybenzidine, 3,3′-diaminodiphenyl ether, 3,4′-diaminodiphenyl ether, 4,4′-diaminodiphenyl ether, 3,3′-diaminodiphenyl sulfide, 3,4′-diaminodiphenyl sulfide, 4,4′-diaminodiphenyl sulfide, 3,3′-diaminodiphenyl sulfoxide, 4,4′-diaminodiphenyl sulfoxide, 3,3′-diaminodiphenyl sulfone, 3,4′-diaminodiphenyl sulfone, 4,4′-diaminodiphenyl sulfone, 3,3′-diaminobenzophenone, 3,4′-diaminobenzophenone, 4,4′-diaminobenzophenone, 3,3′-diaminodiphenylmethane, 3,4′-diaminodiphenylmethane, 4,4′-diaminodiphenylmethane, bis[4-(3-aminophenoxy)phenyl]methane, bis[4-(4-aminophenoxy)phenyl]methane, 1,1-bis[4-(3-aminophenoxy)phenyl]ethane, 1,1-bis[4-(4-aminophenoxy)phenyl]ethane, 1,2-bis[4-(3-aminophenoxy)phenyl]ethane, 1,2-bis[4-(4-aminophenoxy)phenyl]ethane, 2,2-bis[4-(3-aminophenoxy)phenyl]propane, 2,2-bis[4-(4-aminophenoxy)phenyl]propane, 2,2-bis[4-(3-aminophenoxy)phenyl]butane, 2,2-bis[4-(4-aminophenoxy)phenyl]butane, 2,2-bis[4-(3-aminophenoxy)phenyl]-1,1,1,3,3,3-hexafluoro-propane, 2,2-bis[4-(4-aminophenoxy)phenyl]-1,1,1,3,3,3-hexafluoro-propane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 4,4′-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]sulfoxide, bis[4-(4-aminophenoxy)phenyl]sulfoxide, bis[4-(3-aminophenoxy)phenyl]sulfone, bis[4-(4-aminophenoxy)phenyl]sulfone, bis[4-(3-aminophenoxy)phenyl]ether, bis[4-(4-aminophenoxy)phenyl]ether, 1,4-bis[4-(3-aminophenoxy)benzoyl]benzene, 1,3-bis[4-(3-aminophenoxy)benzoyl]benzene, 4,4-bis[3-(4-aminophenoxy)benzoyl]diphenyl ether, 4,4-bis[3-(3-aminophenoxy)benzoyl]diphenyl ether, 4,4-bis[4-(4-amino-α,α-dimethylbenzyl)phenoxy]benzophenone, 4,4-bis[4-(4-amino-α,α-dimethylbenzyl)phenoxy]diphenyl sulfone, bis[4-([4-(4-aminophenoxy)phenoxy]phenyl]ketone, bis[4-([4-(4-aminophenoxy)phenoxy]phenyl]sulfone, 1,4-bis[4-(4-aminophenoxy)-α,α-dimethylbenzyl]benzene, and 1,3-bis[4-(4-aminophenoxy)-α,α-dimethylbenzyl]benzene, which may be used alone or in admixture of any.

Of the diamine compounds illustrated above, preferred are p-phenylenediamine, 4,4′-diaminodiphenyl ether.

The tetracarboxylic acid dianhydrides of the general formula (II) include

those of formula (II) wherein R₂ is an aliphatic radical, such as ethylenetetracarboxylic dianhydride;

those of formula (II) wherein R₂ is a cycloaliphatic radical, such as cyclopentanetetracarboxylic dianhydride;

those of formula (II) wherein R₂ is a monocyclic aromatic radical, such as 1,2,3,4-benzenetetracarboxylic dianhydride and pyromellitic dianhydride;

those of formula (II) wherein R₂ is a fused polycyclic aromatic radical, such as 2,3,6,7-naphthalenetetracarboxylic dianhydride, 1,4,5,8-naphthalenetetracarboxylic dianhydride, 1,2,5,6-naphthalenetetracarboxylic dianhydride, 3,4,9,10-perillenetetracarboxylic dianhydride, 2,3,6,7-anthracenetetracarboxylic dianhydride, and 1,2,7,8-phenanthrenetetracarboxylic dianhydride;

those of formula (II) wherein R₂ is a non-fused cyclic aromatic radical having aromatics joined directly, such as 3,3′,4,4′-biphenyltetracarboxylic dianhydride and 2,2′,3,3′-biphenyltetracarboxylic dianhydride; and

those of formula (II) wherein R₂ is a non-fused cyclic aromatic radical having aromatics joined via a linking member, such as 3,3′,4,4′-benzophenonetetracarboxylic dianhydride, 2,2′,3,3′-benzophenonetetracarboxylic dianhydride, 2,2-bis(3,4-dicarboxyphenyl)propane dianhydride, 2,2-bis(2,3-dicarboxyphenyl)propane dianhydride, bis(3,4-dicarboxyphenyl)ether dianhydride, bis(3,4-dicarboxyphenyl)sulfone dianhydride, bis(2,3-dicarboxyphenyl)sulfone dianhydride, 1,1-bis(2,3-dicarboxyphenyl)ethane dianhydride, bis(2,3-dicarboxyphenyl)methane dianhydride, bis(3,4-dicarboxyphenyl)methane dianhydride, 4,4′-(p-phenylenedioxy)diphthalic dianhydride and 4,4′-(m-phenylenedioxy)diphthalic dianhydride, which may be used alone or in admixture of any.

Of the tetracarboxylic dianhydrides illustrated above, preferred are pyromellitic dianhydride, 3,3′,4,4′-biphenyltetracarboxylic dianhydride.

The thickness of the polyimide film is not particularly limited and may be suitably selected although it is generally in a range of 10 to 50 μm, preferably 12 to 25 μm.

On the other hand, the type of the metal foil used herein is not critical. Often, copper, nickel, aluminum, stainless steel and beryllium-copper alloys are used. Copper foil is most often used as the metal foil for forming printed circuits. The copper foil used herein may be either rolled copper foil or electrolytic copper foil. To enhance the bond strength between a metal foil and a polyimide film in direct contact therewith, a layer of inorganic matter, typically elemental metal or an oxide or alloy thereof may be formed on the metal foil. In the case of a copper foil, for example, a layer of elemental copper, copper oxide, nickel-copper alloy or zinc-copper alloy may be formed on the metal foil. Alternatively, instead of the inorganic matter, coupling agents such as aminosilanes, epoxysilanes and mercaptosilanes may be coated onto the metal foil.

The thickness of the metal foil is not particularly limited and may be suitably selected although it is generally in a range of 3 to 50 μm, preferably 5 to 35 μm.

In the practice of the invention, a polyimide resin layer is disposed between the polyimide film and the metal foil.

The polyimide resin layer used herein is preferably obtained by applying a polyimide resin precursor solution onto the polyimide film or the metal foil, joining them together, then effecting imidization.

The more preferred process involves applying a polyimide resin precursor solution to the polyimide film, joining the polyimide film to the metal foil, then effecting imidization.

A choice of a polyimide resin layer having a glass transition temperature (Tg) of preferably at least 350° C., more preferably 350 to 500° C., most preferably 350 to 450° C. ensures the manufacture of laminates having very high heat resistance.

Further, a choice of a polyimide resin layer having more solvent resistance than a thermoplastic polyimide ensures the manufacture of laminates having very high solvent resistance.

As used herein, the term “solvent resistance” is represented by the peel strength as determined after immersion in a solvent. Examples of the solvent include N-methylpyrrolidone (NMP), dimethylformamide (DMF), dimethylacetamide (DMAc), dimethyl sulfoxide (DMSO), dimethyl sulfate, sulfolane, butyrolactone, cresol, phenol, halogenated phenols, cyclohexanone, dioxane, tetrahydrofuran and diglyme.

As the polyimide resin layer, use may be made of a product obtained from a diamine similar to those represented by formula (I) and exemplified above and a tetracarboxylic dianhydride similar to those represented by formula (II) and exemplified above. The preferred diamine compounds are p-phenylenediamine and 4,4′-diaminodiphenyl ether. The preferred tetracarboxylic dianhydrides are pyromellitic dianhydride and 3,3′,4,4′-biphenyltetracarboxylic dianhydride.

Since the polyimide resin layer used herein can be selected from those resins other than thermoplastic polyimide, resins resistant to solvents may be used. As a result, the reduction of peel strength before and after solvent immersion is suppressed to 50% or less, more preferably 30% or less, most preferably 20% or less.

According to the invention, there is available a flexible metal foil/polyimide laminate having a solvent resistance reduction suppressed to 50% or less, more preferably 30% or less, most preferably 20% or less.

As used herein, the “thermoplastic polyimide” means structures having a Tg of lower than 350° C., as described in Japanese Patent No. 3,320,516 and JP-A 2002-326280 or JP-A 1-244841, JP-A 2000-103010, JP-A 6-190967, etc.

Notably the method and conditions of measuring solvent resistance are described later.

Preferably the polyimide resin layer has a thickness of 1 to 10 μm, especially 2 to 5 μm.

The laminate of the invention permits intentional combination of a polyimide film with a polyimide resin layer, which enables to form a polyimide/metal foil laminate having certain focused properties. For example, using a plasma-pretreated polyimide film, a polyimide/metal foil laminate having good bond strength to an adhesive sheet is obtainable. (Although the polyimide film layer of the polyimide/metal foil laminate can be plasma treated, the use of a plasma-pretreated polyimide film is industrially advantageous.) This polyimide/metal foil laminate is very useful in the manufacture of multilayer flexible printed circuit boards using an adhesive sheet.

In HDD and optical pickup applications, for example, polyimide/metal foil laminates having improved flexural property and improved flexibility are desirable. The flexural property becomes better as the adhesive layer in contact with the metal foil has a higher modulus of elasticity or higher Tg. On the other hand, the flexibility becomes better as the entire resin layer has a lower modulus of elasticity. Therefore, a polyimide/metal foil laminate for a particular purpose can be manufactured by joining a polyimide film having a medium to low modulus of elasticity using a polyimide resin layer having a high modulus of elasticity and a high Tg.

It is noted that in the polyimide film and polyimide resin layer according to the invention, there may be added a coupling agent for enhancing the bond strength to the metal foil, a surfactant for enhancing surface smoothness, and additives or fillers for altering other properties. Also, the polyimide film may be pretreated as by corona treatment, etching treatment or plasma treatment for improving the adhesion thereof.

The methods of preparing the polyimide film and polyimide resin layer according to the invention are not particularly limited and any of prior art well-known methods may be applied.

### EXAMPLE

Synthesis Examples, Examples and Comparative Examples are given below by way of illustration of the invention although the invention is not limited thereto.

### Synthesis Example 1

A three-necked flask equipped with a stirrer and a dropping funnel was placed in an ice water bath and nitrogen gas was flowed. The flask was charged with 29.422 g of 3,3′,4,4′-biphenyltetracarboxylic dianhydride and 200 g of dimethylacetamide (DMAc), which were stirred for 30 minutes. Then 10.814 g of p-phenylenediamine in 100 g of DMAc was added over 15 minutes from the dropping funnel. The resulting mixture was stirred at 10-15° C. for 2 hours and at 25° C. for 6 hours, yielding a homogeneous polyimide resin precursor varnish comprising polyamic acid.

### Synthesis Example 2

A polyimide resin precursor varnish was prepared as in Synthesis Example 1 except that 29.422 g of 3,3′,4,4′-biphenyltetracarboxylic dianhydride, 3.003 g of 4,4′-diaminodiphenyl ether and 9.192 g of p-phenylenediamine were used, and 300 g in total of a 2.5/1 (weight ratio) mixture of dimethylacetamide (DMAc) and N-methylpyrrolidone (NMP) was used as the solvent.

### Example 1

The polyimide resin precursor varnish of Synthesis Example 1 was applied to a commercial electrolytic copper foil of 9 μm thick (trade name FI-WS by Furukawa Circuit Foil Co., Ltd.) to a buildup of 50 μm and dried by a blow dryer. Thereafter, it was joined to a commercial polyimide film of 50 μm thick (trade name Upilex-S by Ube Industries, Ltd.) at a temperature of 80° C., using a roll press machine. Then the residual solvent was removed by means of a blow dryer at 150° C., after which the assembly was heated to 350° C. in a nitrogen gas atmosphere for imidization of the precursor, yielding a flexible copper foil laminate consisting of polyimide film, polyimide resin layer and copper foil. The laminate thus obtained was determined for soldering heat resistance, glass transition temperature (Tg), and solvent resistance.

### Example 2

The polyimide resin precursor varnish of Synthesis Example 2 was applied to a commercial rolled copper foil of 18 μm thick (trade name BHY by Japan Energy Co., Ltd.) to a buildup of 50 μm and dried by a blow dryer as in Example 1. Thereafter, it was joined to a commercial polyimide film of 25 μm thick (trade name Apical NPI by Kaneka Corp.) as in Example 1. By following the subsequent procedure of Example 1, a flexible polyimide/copper foil laminate was obtained. The laminate thus obtained was determined for soldering heat resistance, Tg, and solvent resistance.

### Comparative Example 1

A thermoplastic polyimide (commercially available Upisel N by Ube Industries, Ltd.) was applied to a polyimide film, after which the film was joined to a copper foil. As in Example 1, the laminate was determined for soldering heat resistance, Tg (catalogue value), and solvent resistance.

It is noted that Upisel N has a Tg of 242° C. (catalogue value) and an imidization degree of 100%.

Measurement of Soldering Heat Resistance

A laminate sample (25 mm long×25 mm wide) was immersed in a solder bath at 350° C. for 30 seconds after which it was visually inspected for peeling and blisters and rated according to the following criterion.

Rating

OK: no peel nor blister

NG: peeled or blisters

Measurement of Tq

The polyimide resin precursor of Synthesis Example 1 or 2 was coated onto a glass plate, dried at 50° C. for 30 minutes for removing the solvent, and stripped from the glass plate, obtaining a sheet sample of the polyimide precursor resin solution composition having a thickness of 3 mm. The sheet sample was heated at 350° C. for 5 hours for imidization. The Tg of the imidized sample was measured using a thermal analyzer Model RSA-III (Rheometric Science).

Solvent Resistance

According to JIS C6471, the sample having formed a circuit of 1 mm wide was tested for peel strength by peeling at a pulling speed of 50 mm/min and an angle of 90°, before and after immersion in dimethylacetamide at room temperature (25° C.) for 5 hours.

The results are shown in Table 1.

TABLE 1

| | | | Comparative |
|---|---|---|---|
| | Example 1 | Example 2 | Example 1 |
| Soldering heat resistance | OK | OK | NG |
| Tg | 360° C. | 430° C. | 242° C. |

Solvent resistance

| | | | |
|---|---|---|---|
| Before immersion | 1.2 kgf/cm | 1.1 kgf/cm | 1.2 kgf/cm |
| After immersion | 0.9 kgf/cm | 0.9 kgf/cm | 0.3 kgf/cm |
| Reduction | 25% | 18% | 75% |

According to the invention, polyimide/metal foil laminates can be readily provided without detracting from the favorable properties of polyimide film including heat resistance and solvent resistance. Possible combinations of different polyimide films with different polyimide resin layers enable easy manufacture of flexible polyimide/metal foil laminates having certain features.

1-3. (canceled)

4. A flexible metal foil/polyimide laminate consisting of all three layers, a polyimide film, a metal foil, and a polyimide resin layer disposed between the polyimide film and the metal foil, said polyimide resin layer having a glass transition temperature of at least 350° C. and a solvent resistance reduction of 50% or less.

5. The laminate film of claim 4, wherein said polyimide resin layer has a glass transition temperature of 430 to 500° C.

6. The laminate of claim 4 or 5, wherein said polyimide resin layer has more solvent resistance than a thermoplastic polyimide.

7. The laminate of claim 4 or 5, wherein said polyimide resin layer has a solvent resistance reduction of 30% or less.
